(19) United States
(12) Patent Application Publication
(10) Pub. No.: US 2015/0185493 A1
(43) Pub. Date: Jul. 2, 2015

(54) ZOOM LENS AND IMAGE PICKUP APPARATUS INCLUDING THE SAME

(71) Applicant: CANON KABUSHIKI KAISHA, Tokyo (JP)

(72) Inventor: Koji Aoki, Saitama-shi (JP)

(21) Appl. No.: 14/564,525

(22) Filed: Dec. 9, 2014

(30) Foreign Application Priority Data
Dec. 26, 2013 (JP) 2013-269056

(51) Int. Cl. G02B 27/64; G02B 15/16

(52) U.S. Cl. CPC G02B 27/646; G02B 15/16

(57) ABSTRACT

A zoom lens includes, in order from an object side: a positive first lens unit; a negative second lens unit; a positive third lens unit; and a rear lens unit including at least one lens unit. In the zoom lens, an interval between adjacent lens units is changed during zooming, at least a part of the second lens unit is a correction lens unit rotatable during image blur correction with one point located on an optical axis or near the optical axis as a center of rotation located closer to the image side than an intersection between the optical axis and a lens surface of the correction lens unit closest to the object side, and a distance in a direction of the optical axis from the intersection to the center of rotation and a thickness of the correction lens unit on the optical axis are appropriately set.

### BACKGROUND OF THE INVENTION

1. Field of the Invention

The present invention relates to a zoom lens and an image pickup apparatus including the same, which are suitable for an image pickup apparatus using an image pickup element, such as a video camera, an electronic still camera, a broadcasting camera, or a monitoring camera, or an image pickup apparatus such as a silver halide film camera.

2. Description of the Related Art

A zoom lens having a short total lens length (a distance from a first lens surface to an image plane), a high zoom ratio, and a high optical characteristic in the entire zoom range is required for a photographing optical system for use in an image pickup apparatus. The zoom lens having a high zoom ratio has a tendency that the entire system becomes large and the weight becomes heavy.

When the zoom lens becomes large in size and heavy, in general, the zoom lens is vibrated due to shaking or the like during the photographing in many cases, and hence the image blur is more liable to occur in the photographed image.

There is known a zoom lens in which a part of a lens system is shifted in a direction perpendicular to an optical axis, to thereby correct the image blur. In Japanese Patent Application Laid-Open No. H10-260356, in a four-unit zoom lens including, in order from an object side to an image side, first to fourth lens units having positive, negative, positive, and positive refractive powers, respectively, the image blur is corrected by shifting the third lens unit.

In Japanese Patent Application Laid-Open No. H10-090601, in a five-unit zoom lens including, in order from an object side to an image side, first to fifth lens units having positive, negative, positive, negative, and positive refractive powers, respectively, the image blur is corrected by shifting the fourth lens unit. In addition, there is known a zoom lens in which a part of a lens system is rotated (tilted) with a point located on an optical axis as a center, to thereby correct the image blur. In Japanese Patent Application Laid-Open No. H06-160778, in a four-unit zoom lens including, in order from an object side to an image side, first to fourth lens units having positive, negative, positive, and positive refractive powers, respectively, the image blur is corrected by tilting (rotating) the first lens unit.

In addition, there is known a zoom lens in which an image stabilization unit as a part of lens unit is shifted in a direction perpendicular to an optical axis, and is rotated with one point located on the optical axis as a center of rotation, to thereby correct the image blur. In Japanese Patent Application Laid-Open No. H05-232410, in, a four-unit zoom lens including, in order from an object side to an image side, first to fourth lens units having positive, negative, positive, and positive refractive powers, respectively, the image blur is corrected by shifting and tilting the second lens unit.

In general, in order to precisely carry out the image blur correction and reduce an aberration variation during the image blur correction in the zoom lens having an image stabilization function, it is important to appropriately set a lens configuration of the zoom lens, a lens configuration of the image stabilization unit for the image blur correction, and the like. If the lens configuration of the image stabilization unit, which is moved for the image blur correction, is not proper, the image blur correction becomes insufficient, an amount of occurrence of an eccentric aberration during the vibration compensation is increased, and it becomes difficult to maintain a high optical characteristic during the vibration compensation.

### SUMMARY OF THE INVENTION

According to one embodiment of the present invention, there is provided a zoom lens, including, in order from an object side to an image side: a first lens unit having a positive refractive power; a second lens unit having a negative refractive power; a third lens unit having a positive refractive power; and a rear lens unit including at least one lens unit, the zoom lens being configured such that an interval between two lens units adjacent to each other is changed during zooming, in which at least a part of the second lens unit is a correction lens unit rotatable during an image blur correction with one point located on an optical axis or near the optical axis as a center of rotation, the center of rotation being located closer to the image side than an intersection point between the optical axis and a lens surface of the correction lens unit where the lens surface is disposed closest to the object side, and in which the following conditional expression is satisfied:

0.5<|R/d2is|<17.5,

where R represents a distance in a direction of the optical axis from the intersection point to the center of rotation, and d2is represents a thickness of the correction lens unit on the optical axis.

Further features of the present invention will become apparent from the following description of exemplary embodiments with reference to the attached drawings.

### BRIEF DESCRIPTION OF THE DRAWINGS

FIG. 1 is a lens cross-sectional view: (A) at a wide angle end; (B) at an intermediate zoom position; and (C) at a telephoto end of a zoom lens according to Embodiment 1 (Numerical Embodiment 1) of the present invention.

FIG. 2A is a longitudinal aberration diagram at the wide angle end according to Embodiment 1 (Numerical Embodiment 1) of the present invention.

FIG. 2B is a longitudinal aberration diagram at the intermediate zoom position according to Embodiment 1 (Numerical Embodiment 1) of the present invention.

FIG. 2C is a longitudinal aberration diagram at the telephoto end according to Embodiment 1 (Numerical Embodiment 1) of the present invention.

FIG. 3A is a lateral aberration diagram a the wide angle end according to Embodiment 1 (Numerical Embodiment 1) of the present invention.

FIG. 3B is a lateral aberration diagram at the intermediate zoom position according to Embodiment 1 (Numerical Embodiment 1) of the present invention.

FIG. 3C is a lateral aberration diagram at the telephoto end according to Embodiment 1 (Numerical Embodiment 1) of the present invention.

FIG. 4A is a lateral aberration diagram at the wide angle end during an image blur correction according to Embodiment 1 (Numerical Embodiment 1) of the present invention.

FIG. 4B is a lateral aberration diagram at the intermediate zoom position during the image blur correction according to Embodiment 1 (Numerical Embodiment 1) of the present invention.

FIG. 4C is a lateral aberration diagram at the telephoto end during the image blur correction according to Embodiment 1 (Numerical Embodiment 1) of the present invention.

FIG. 5 is a lens cross-sectional view: (A) at a wide angle end; (E) at an intermediate zoom position; and (C) at a telephoto end of a zoom lens according to Embodiment 2 (Numerical Embodiment 2) of the present invention.

FIG. 6A is a longitudinal aberration diagram at the wide angle end according to Embodiment 2 (Numerical Embodiment 2) of the present invention.

FIG. 6B is a longitudinal aberration diagram at the intermediate zoom position according to Embodiment 2 (Numerical Embodiment 2) of the present invention.

FIG. 6C is a longitudinal aberration diagram at the telephoto end according to Embodiment 2 (Numerical Embodiment 2) of the present invention.

FIG. 7A is a lateral aberration diagram at the wide angle according to Embodiment 2 (Numerical Embodiment 2) of the present invention.

FIG. 7B is a lateral aberration diagram at the intermediate zoom position according to Embodiment 2 (Numerical Embodiment 2) of the present invention.

FIG. 7C is a lateral aberration diagram at the telephoto end according to Embodiment 2 (Numerical Embodiment 2) of the present invention.

FIG. 8A is a lateral aberration diagram at the wide angle end during an image blur correction according to Embodiment 2 (Numerical Embodiment 2) of the present invention.

FIG. 8B is a lateral aberration diagram at the intermediate zoom position during the image blur correction according to Embodiment 2 (Numerical Embodiment 2) of the present invention.

FIG. 8C is a lateral aberration diagram at the telephoto end during the image blur correction according to Embodiment 2 (Numerical Embodiment 2) of the present invention.

FIG. 9 is a lens cross-sectional view: (A) at a wide angle end; (B) at an intermediate zoom position; and (C) at a telephoto end of zoom lens according to Embodiment 3 (Numerical Embodiment 3) of the present invention.

FIG. 10A is a longitudinal aberration diagram at the wide angle end according to Embodiment 3 (Numerical Embodiment 3) of the present invention.

FIG. 10B is a longitudinal aberration diagram at the intermediate zoom position according to Embodiment 3 (Numerical Embodiment 3) of the present invention.

FIG. 10C is a longitudinal aberration diagram at the telephoto end according to Embodiment 3 (Numerical Embodiment 3) of the present invention.

FIG. 11A is a lateral aberration diagram at the wide angle end according to Embodiment 3 (Numerical Embodiment 3) of the present invention.

FIG. 11B is a lateral aberration diagram at the intermediate zoom position according to Embodiment 3 (Numerical Embodiment 3) of the present invention.

FIG. 11C is a lateral aberration diagram at the telephoto end according to Embodiment 3 (Numerical Embodiment 3) of the present invention.

FIG. 12A is a lateral aberration diagram at the wide angle end during an image blur correction according to Embodiment 3 (Numerical Embodiment 3) of the present invention.

FIG. 12B is a lateral aberration diagram at the intermediate zoom position during the image blur correction according to Embodiment 3 (Numerical Embodiment 3) of the present invention.

FIG. 12C is a lateral aberration diagram at the telephoto end during the image blur correction according to Embodiment 3 (Numerical Embodiment 3) of the present invention.

FIG. 13 is a schematic view illustrating a main part of an image pickup apparatus of the present invention.

FIG. 14 is an explanatory view illustrating a correction lens unit during the image blur correction of the present invention.

### DESCRIPTION OF THE EMBODIMENTS

Now, exemplary embodiments of the present invention are described in detail with reference to the attached drawings. A zoom lens of the present invention includes, in order from an object side to an image side, a first lens unit having a positive refractive power, a second lens unit having a negative refractive power, a third lens unit having a positive refractive power, and a rear lens unit including one or more lend units. During zooming, an interval between two lens units which are adjacent to each other is changed. Here, it is only necessary that the lens unit include one or more lenses, and hence the lens unit may not necessarily include a plurality of lenses. All of or a part of the second lens unit is a correction lens unit rotatable with one point located on an optical axis or near the optical axis as a center of rotation during correction of an image blur.

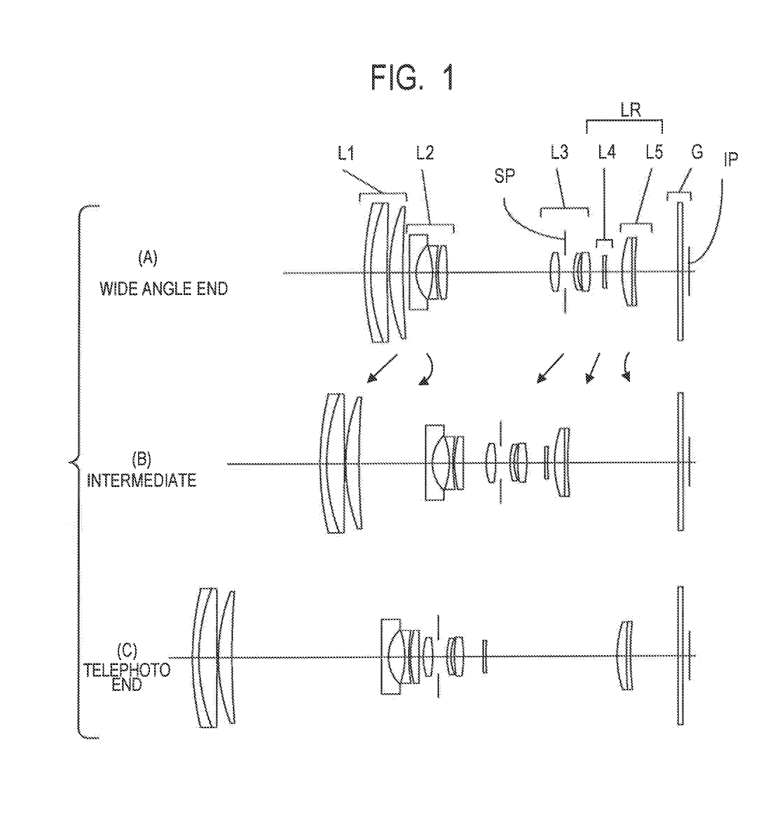

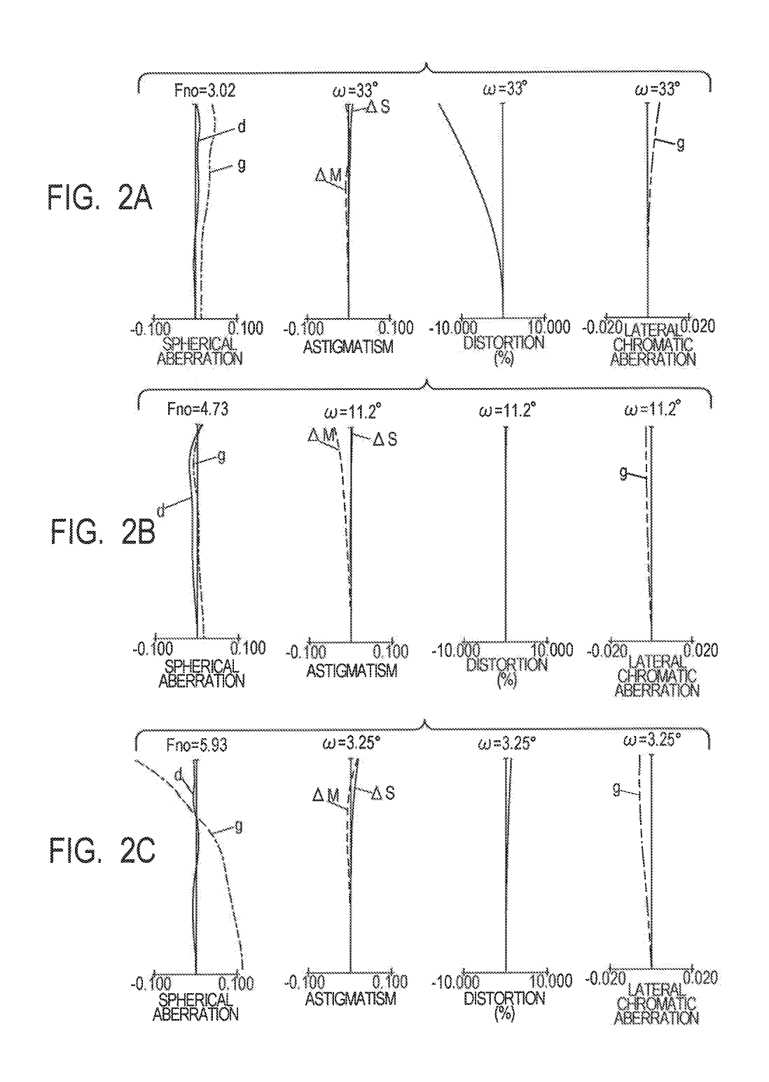

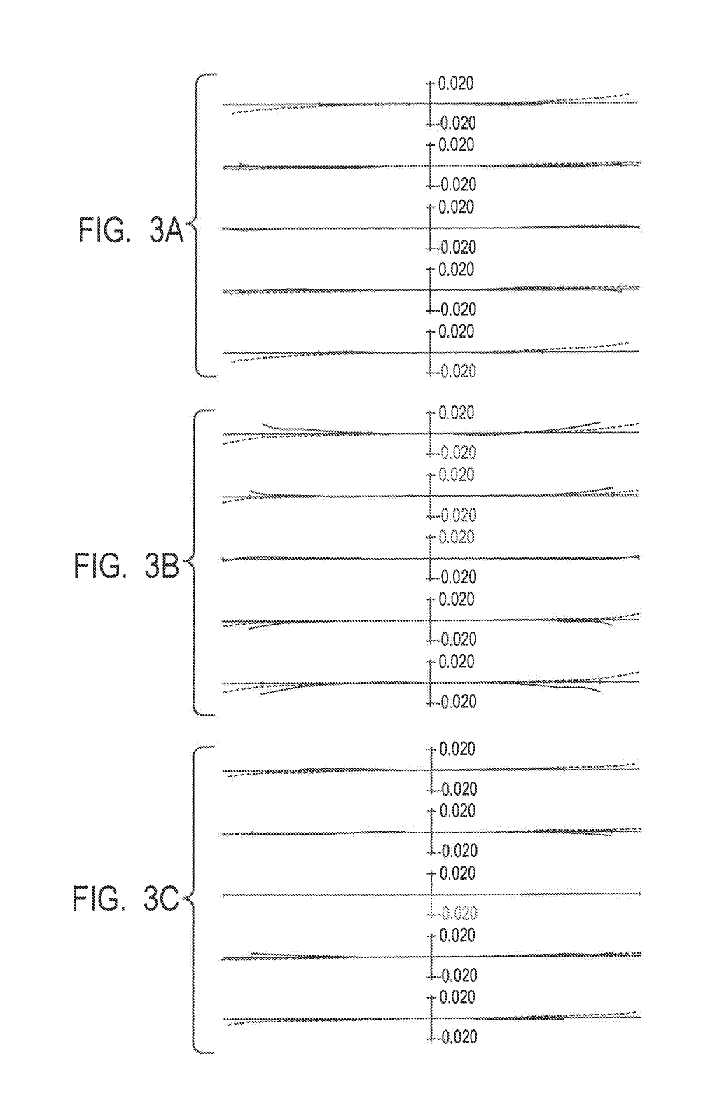

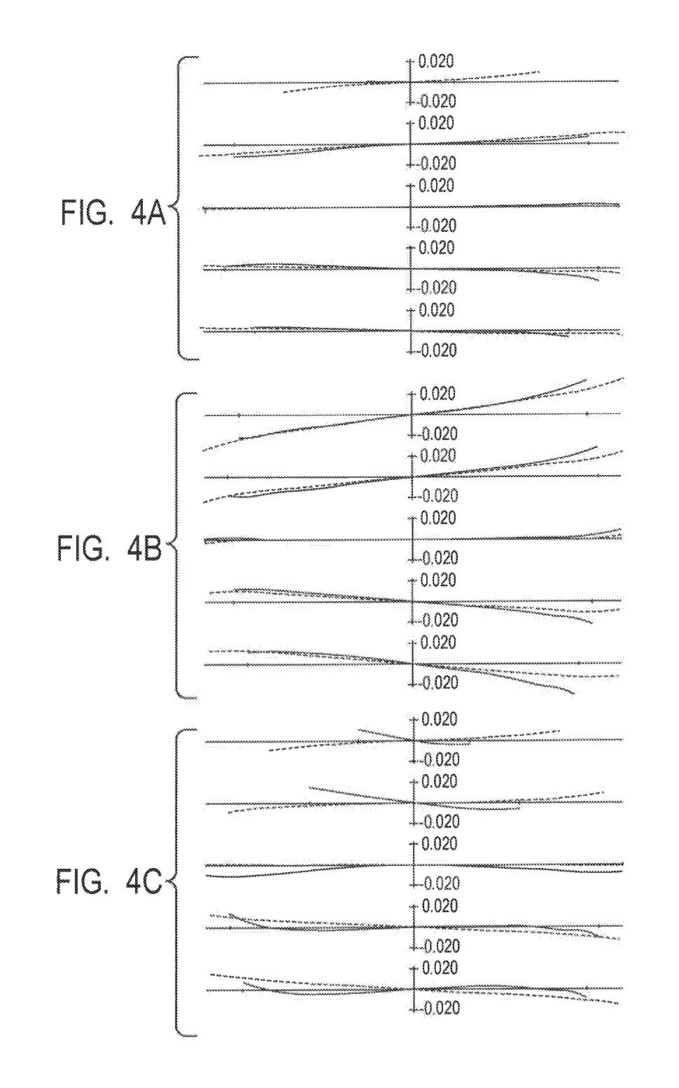

FIG. 1 is a lens cross-sectional view: (A) at a wide angle end; (B) at an intermediate zoom position; and (C) at a telephoto end of Embodiment 1 of the present invention. FIGS. 2A, 2B, and 2C are respectively longitudinal aberration diagrams at the wide angle end, at the intermediate zoom position, and at the telephoto end in a zoom lens of Embodiment 1 FIGS. 3A, 3B, and 3C are respectively lateral aberration diagrams at the wide angle end, at the intermediate zoom position, and at the telephoto end in the zoom lens of Embodiment 1. FIGS. 4A, 4B, and 4C are respectively lateral aberration diagrams at the wide angle end, at the intermediate zoom position, and at the telephoto end during an image blur correction of the zoom lens of Embodiment 1. The zoom lens of Embodiment 1 has a zoom ratio of 13.31 and an aperture ratio of approximately 3.02 to 5.93.

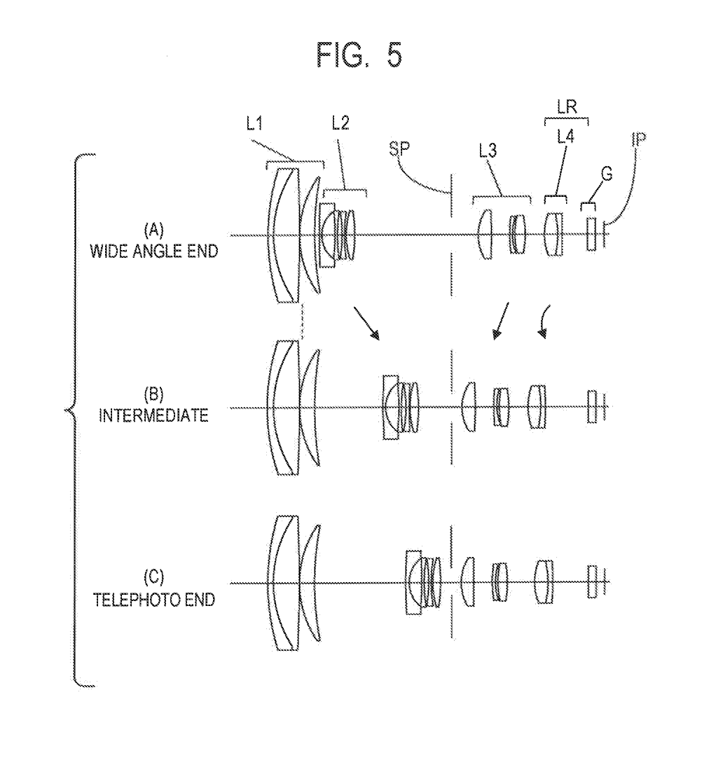

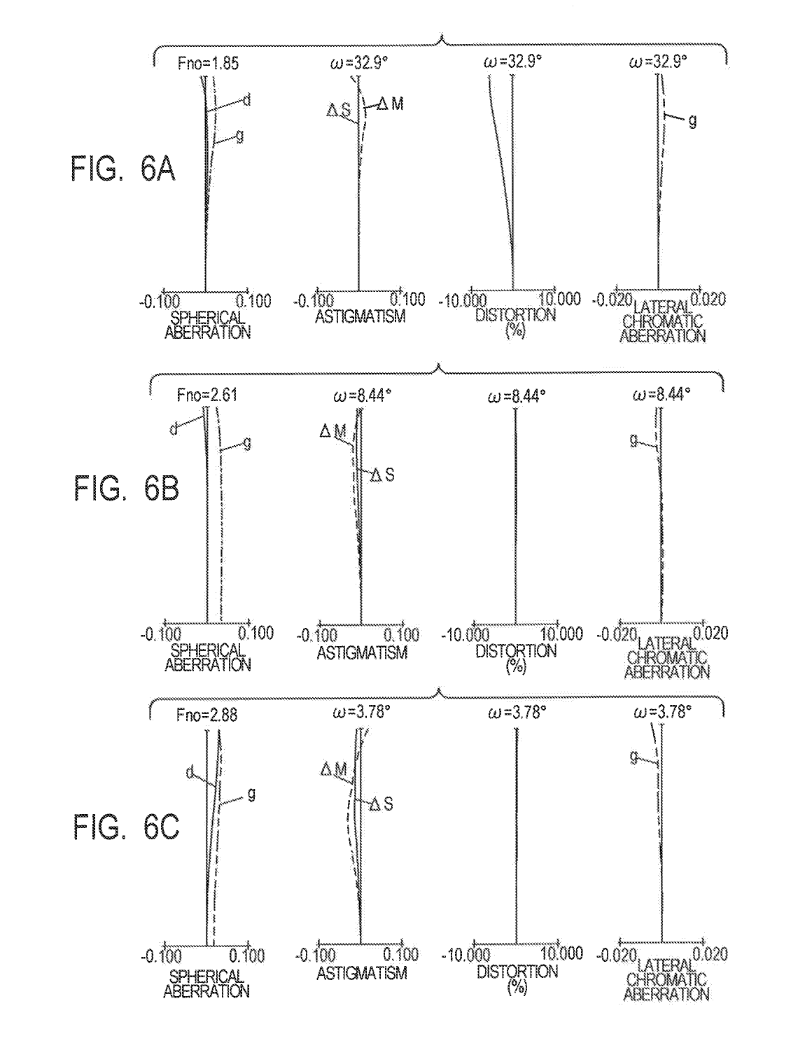

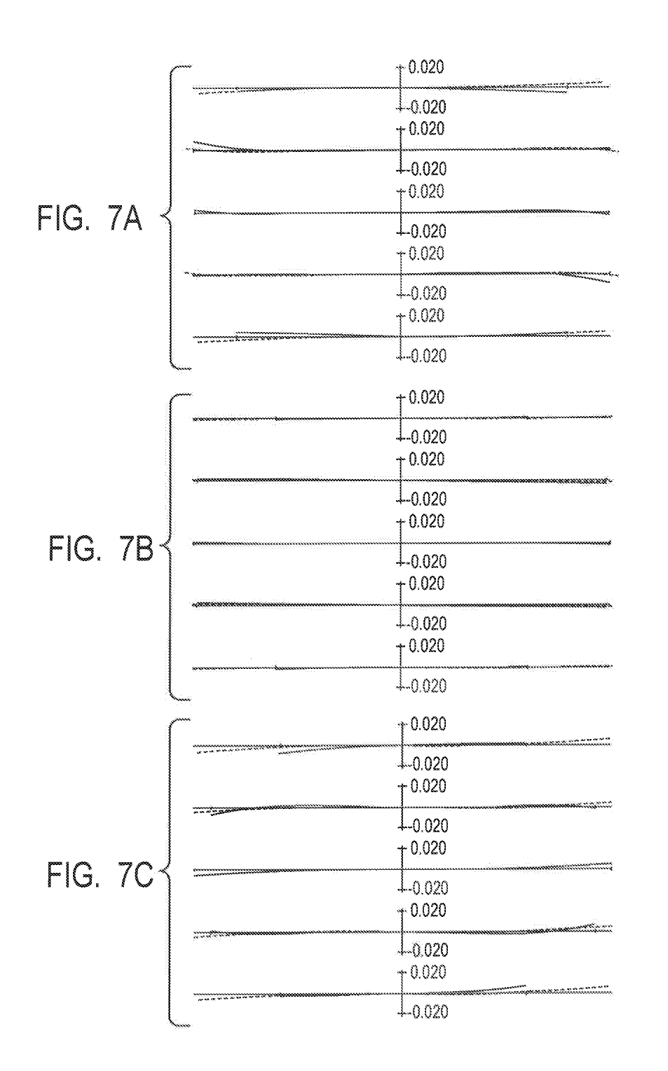

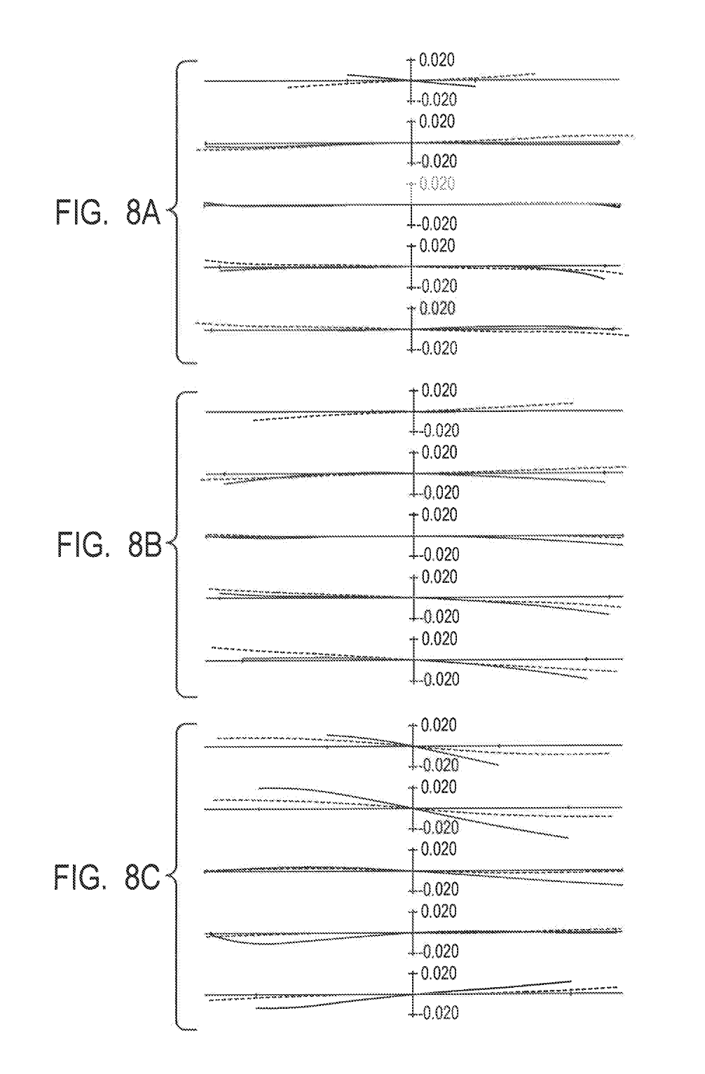

FIG. 5 is a lens cross-sectional view: (A) at a wide angle end; (B) at an intermediate zoom position; and (C) at a telephoto end of Embodiment 2 of the present invention. FIGS. 6A, 6B, and 6C are respectively longitudinal aberration diagrams at the wide angle end, at the intermediate zoom position, and at the telephoto end in a zoom lens of Embodiment 2. FIGS. 7A, 7B, and 7C are respectively lateral aberration diagrams at the wide angle end, at the intermediate zoom position, and at the telephoto end in the zoom lens of Embodiment 2. FIGS. 8A, 8B, and 8C are respectively lateral aberration diagrams at the wide angle end, at the intermediate zoom position, and at the telephoto end during an image blur correction of the zoom lens of Embodiment 2. The zoom lens of Embodiment 2 has a zoom ratio of 9.80 and an aperture ratio of approximately 1.85 to 2.88.

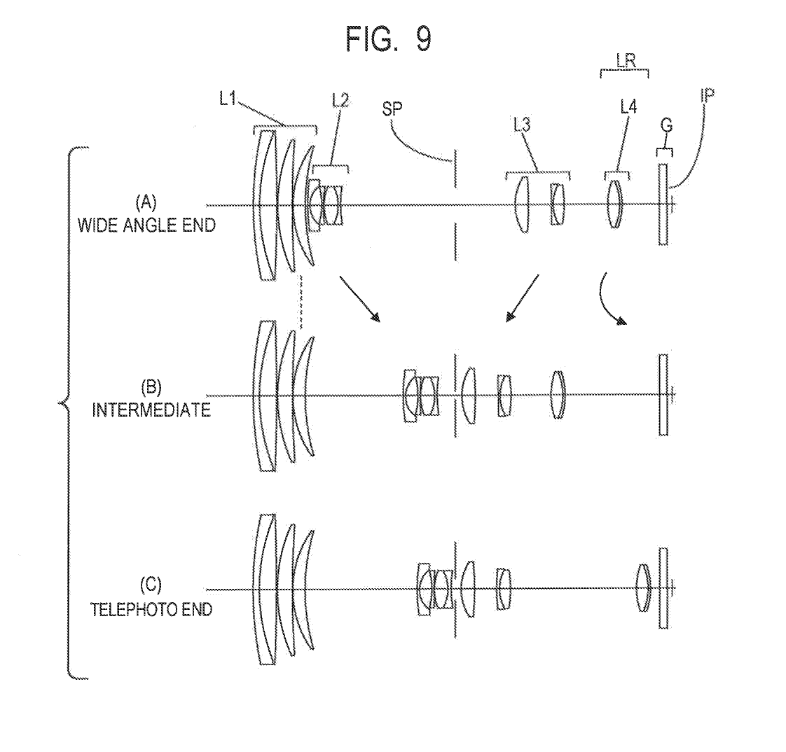

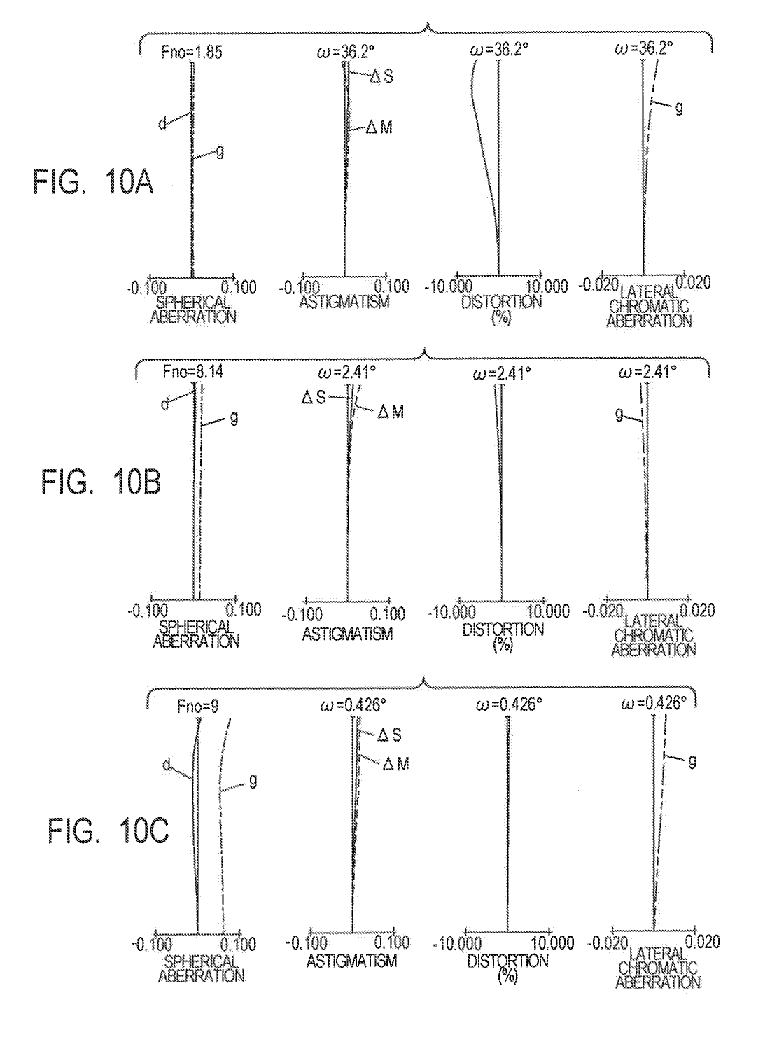

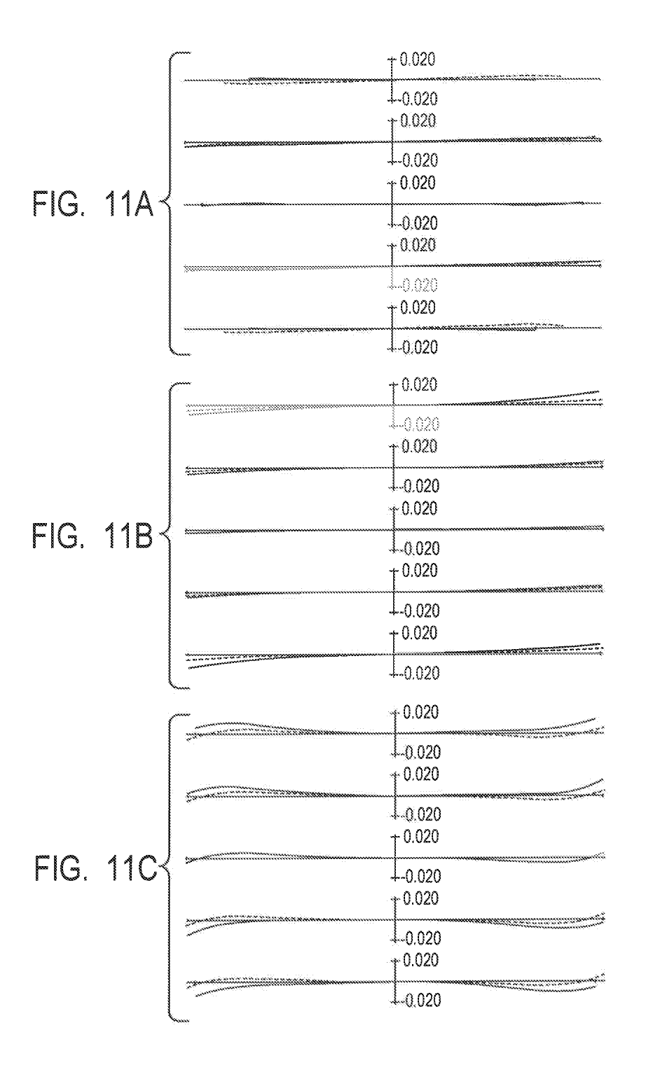

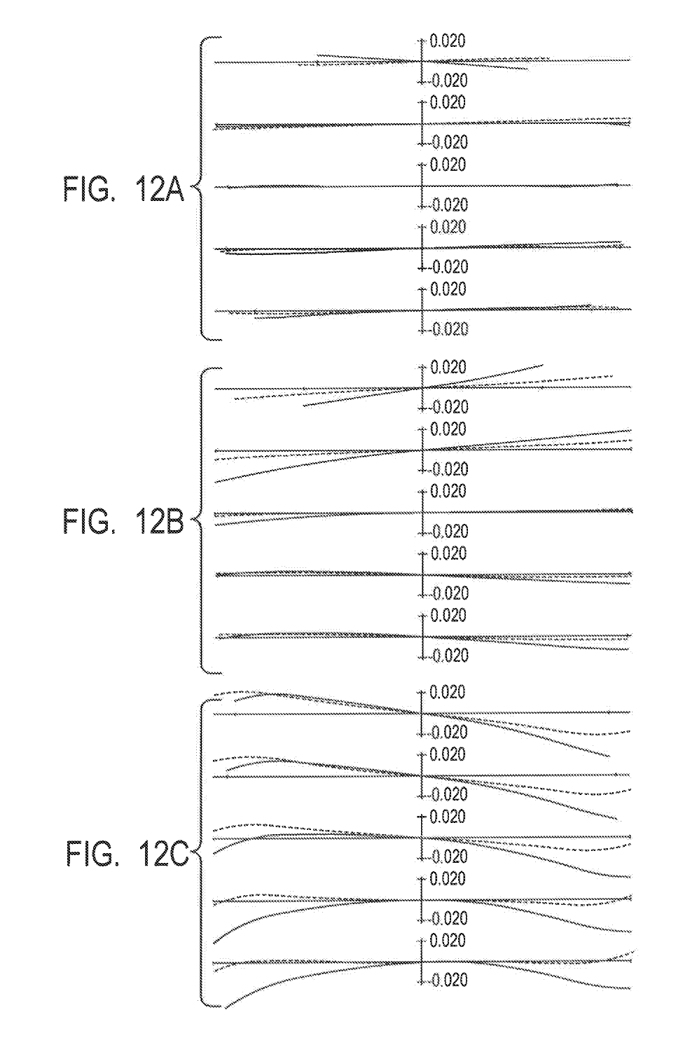

FIG. 9 is a lens cross-sectional view: (A) at a wide angle end; (B) at an intermediate zoom position; and (C) at a telephoto end of Embodiment 3 of the present invention. FIGS. 10A, 10B, and 10C are respectively longitudinal aberration diagrams at the wide angle end, at the intermediate zoom position, and at the telephoto end in a zoom lens of Embodiment 3. FIGS. 11A, 11B, and 11C are respectively lateral aberration diagrams at the wide angle end, at the intermediate zoom position, and at the telephoto end in the zoom lens of Embodiment 3. FIGS. 12A, 12B, and 12C are respectively lateral aberration diagrams at the wide angle end, at the intermediate zoom position, and at the telephoto end during an image blur correction of the zoom lens of Embodiment 3. The zoom lens of Embodiment 3 has a zoom ratio of 98.52 and an aperture ratio of approximately 1.85 to 9.00.

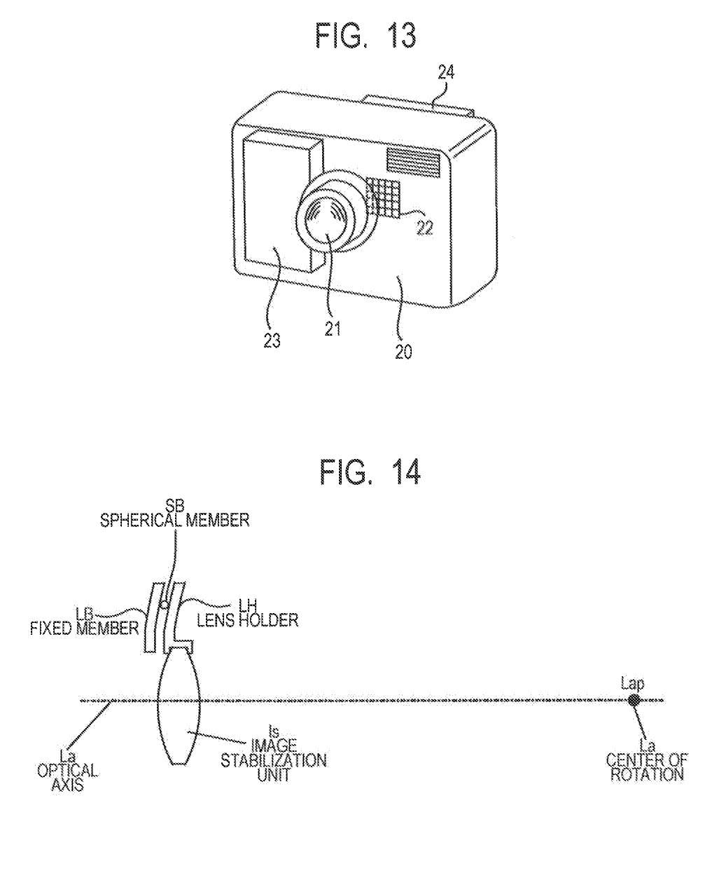

FIG. 13 is a schematic view or a main part of an image pickup apparatus of the present invention. FIG. 14 is an explanatory view during the image blur correction of the correction lens unit according to the present invention.

The zoom lens of the present invention is used for an image pickup apparatus such as a digital camera, a video camera, or a silver halide film camera. In the lens cross sections, the left side is a front side (object side or magnification side) while the right side is a rear side (image side or redaction side). In the lens cross sections, symbol i indicates an order of lens units from the object side to the image side, and symbol Li represents an i-th lens unit. Symbol LR indicates a rear lens unit including one or more lens units. An f number determination member (hereinafter referred to also as “aperture stop”) SP has a function of aperture stop for determining (limiting) a maximum f number (Fno) light flux.

An optical block G corresponds to an optical filter, a face plate, a quartz low-pass filter, an infrared cut filter, or the like. As an image plane IP, an imaging plane of an image pickup element (photo-electric conversion element) such as a COD sensor or a CMOS sensor is arranged when the zoom lens is used as a photographing optical system for use in a video camera or a digital still camera. Alternatively, a photosensitive surface corresponding to a film surface is arranged when the zoom lens is used as a photographing optical system of a silver halide film camera.

In the longitudinal aberration diagrams, symbols d and g in a spherical aberration diagram represent a d-line and a g-line, respectively, symbol ΔM in an astigmatism diagram represents a meridional image plane, symbol ΔS in the astigmatism diagram represents a sagittal image plane, and symbol g in a lateral chromatic aberration diagram represents g-line. The lateral aberration diagrams show, in order from an upper side, aberration diagrams of the d-line at image heights of 100%, 70%, the center, 70% on an opposite side, and 100% on the opposite side. A broken line indicates the sagittal image plane and a solid line indicates the meridional image plane. Symbol Eno represents an f number and symbol ω represents a half angle of field (degrees). The half angle of field ω represents a value in terms of a ray tracing value. In the lens cross-sectional views, arrows indicate movement loci of the respective lens units from the wide angle end to the telephoto end during the zooming.

In Embodiments described below, the wide angle end and the telephoto end respectively mean the zoom positions when a variable power lens unit is located at ends in a range in which the variable power lens unit can be mechanically moved on the optical path. The features of the zoom lens of Embodiment 1 are now described. In the lens cross-sectional view of FIG. 1, a first lens unit L1 has the positive refractive power, a second lens unit L2 has the negative refractive power, a third lens unit L3 has the positive refractive power, to fourth lens unit L4 has the negative refractive power, and a fifth lens unit L5 has positive refractive power. A rear lens unit LR consists of the fourth lens unit L4 and the fifth lens unit L5.

In the zoom lens of Embodiment 1, the lens units are moved during the zooming. A change in interval between adjacent lens units at the telephoto end with respect to the wide angle end is as follows. An interval between the first lens unit L1 and the second. lens unit L2 is widened. An interval between the second lens unit L2 and the third lens unit L3 is narrowed. An interval between the third lens unit L3 and the fourth lens unit L4 is widened. An interval between the fourth lens unit L4 and the fifth lens unit L5 is widened.

In addition, at the telephoto end, with respect to the wide angle end, all of the first lens unit L1, the second lens unit L2, the third lens unit L3, the fourth lens unit L4, and the fifth lens unit L5 are located on the object side. In addition, the second lens unit L2 is moved along a locus convex to the image side, and the fifth lens unit L5 is moved along a locus convex to the object side. In the manner as described above, the lens units are appropriately moved, to thereby realize the reduction in size and high zoom ratio of the entire system.

An aperture stop SP is arranged within the third lens unit L3. By arranging the aperture stop SP at such a position, the interval between the second lens unit L2 and the third lens unit L3 at the telephoto end becomes narrow, and a change amount of the interval between the second lens unit L2 and the third lens unit L3 for the zooming is ensured to be sufficiently large.

Note that the aperture stop SP may be arranged on the object side of the third lens unit L3. In this case, because an interval between the first lens unit L1 and the aperture stop SP can be shortened, an effective diameter of a front lens becomes easy to reduce in size. In addition, the aperture stop SP may be arranged on the image side of the third lens unit L3. In this case, the movement stroke between the second lens unit L2 and the third lens unit L3 during the zooming can be set long, and hence the high zoom ratio becomes easy to attain.

The aperture stop SP is moved integrally with the third lens unit L3 (so as to draw the same locus) during the zooming. By moving the third lens unit L3 in such a manner, an increase in lens diameter of the third lens unit L3 is reduced. Note that, during the zooming, the aperture stop SP may be moved along a locus different from (independently of) that of the third lens unit L3. In this case, the increase in effective diameter of the front lens determined on the wide angle side becomes easy to reduce.

Next, the zoom lens of Embodiment 2 illustrated in FIG. 5 and the zoom lens of Embodiment 3 illustrated in FIG. 9 are described. In the lens cross-sectional views of FIGS. 5 and 9, a first lens unit L1 has a positive refractive power, a second lens unit L2 has a negative refractive power, a third lens unit L3 has a positive refractive power, and a fourth lens unit L4 has a negative refractive power. A rear lens unit LR consists of the fourth lens unit L4.

In the zoom lenses of Embodiments 2 and 3, during the zooming, the second lens unit L2, the third lens unit and the fourth lens unit L4 are moved. At the telephoto end, with respect to the wide angle end, a change in interval between adjacent lens units is as follows. An interval between the first lens unit L1 and the second lens unit L2 is widened. An interval between the second lens unit L2 and the third lens unit L3 is narrowed. An interval between the third lens unit L3 and the fourth lens unit L4 is widened.

In the zoom lenses of Embodiments 2 and 3, during the zooming, the first lens unit L1 and the aperture stop SP do not move. At the telephoto end, with respect to the wide angle end, the second lens unit L2 is moved to the image side and the third lens unit L3 is moved to the object side. The fourth lens unit L4 is moved along a locus convex to the object side.

In the manner as described above, the lens units L2 to L4 are appropriately moved, to thereby realize the reduction in size and high zoom ratio of the entire system.

In order to correct the image blur on an imaging plane, the zoom of each Embodiment includes a correction lens unit which is to be rotated with a point located on the optical axis or near the optical axis as a center. In any of the zoom lenses of Embodiments, the second lens unit L2 is the correction lens unit.

The correction lens unit is rotated with a point, which is apart from the correction lens unit at a finite distance on the optical axis, as the censer of rotation to be moved so as to have a component (shift component) in a direction perpendicular to the optical axis, and at the same time, to be moved so as to have a component (tilt component) having a tilt with respect to the optical axis. An effect for the image blur correction is obtained through addition of the shift component. Through addition of the tilt component, an effect for reducing an eccentric aberration occurring when the correction lens unit is decentered is obtained. Aberrations occurring at the eccentricity include an eccentric coma, an eccentric astigmatism, and a tilt of the image plane. A suitable tilt component is set with respect to the shift component is that those eccentric aberrations are easily reduced.

The correction lens unit is rotated with a certain point located on the optical axis as the center. In this case, the center of rotation position is suitably set in the optical axis direction, to thereby effectively reduce the eccentric aberration by the tilt component. It is preferred that the lens unit closer to the object side than the aperture stop SP be selected as the correction lens unit because the increase in effective diameter of the front lens can be reduced in this case. A change in height of entrance at which a light flux passes through the lens during the image blur correction is larger in the lens unit on the object side of the correction lens unit.

Therefore, if a lens unit as close as possible to the object used as the correction lens unit, it is possible to suppress the change in height of entrance at which the light flux passes through the lens in the front lens (the first lens unit L1) during the image blur correction. As a result, a peripheral light amount becomes easy to sufficiently ensure. On the other hand, when a predetermined peripheral light amount ratio is supposed to be ensured, the size of the effective diameter of the front lens is easily reduced.

From the above-mentioned viewpoint, firstly, it is considered that the first lens it is used as the correction lens unit. In general, however, in a case of a positive-lead type zoom lens including, in order from an object side to an image side, a first lens unit having a positive refractive power and to second lens unit having a negative refractive power, an effective diameter of the first lens unit is increased. For this reason, the first lens unit is heavy and hence it is difficult to drive the first lens unit with high responsiveness in response to the image blur.

Therefore, from the viewpoints of the suppression of the deterioration of the optical characteristic during the image blur correction, the securement of the peripheral light amount, the reduction in size of effective diameter of the front lens, the reduction in weight of the correction lens unit, and the like, in the zoom lenses of Embodiments, the second lens unit L2 is used as the correction lens unit. Note that a part of the lens units in the second lens unit L2 may be used as the correction lens unit.

FIG. 14 is an explanatory view of a method of driving the correction lens unit. As illustrated in FIG. 14, as a configuration for realizing the rotation of the correction lens unit, there is considered a configuration in which several spherical members SE are held between a lens holder LH and a fixed member LB adjacent to the lens holder LH. The lens holder LH can be moved with respect to the fixed member LB by the rolling of the spherical members SB. In this case, a surface of the fixed member LB for receiving the spherical members SB has a spherical shape so that the correction lens unit can be rotated. None that, a center of rotation of the rotation corresponds to a spherical center of the receiving surface. During the zooming, it is only necessary that the lens holder LH, the spherical members SB, and the fixed member LB be integrally moved in the optical axis direction.

In this case, however, a distance from the lens holder LH to a center of rotation La may be fixed irrespective of the zooming. With such a simple driving mechanism, the shift component and the tilt component of the desired correction lens unit can be generated. Note that how the correction lens unit is moved according to each Embodiment is not necessarily limited to the rotation along the spherical shape. An aspherical shape slightly deviating from the spherical shape, for example, a paraboloidal shape or an ellipsoid shape may also be used instead.

In each Embodiment, when the center of rotation during the image blur correction is located closer to the image side than an intersection point between the optical axis and the lens surface of the correction lens unit, which is closest to the object side, the following conditional expression is satisfied:

0.5|R/d2is|<17.5, (1)

where d2is represents a thickness of the correction lens unit on the optical axis, and R represents a distance from the intersection point to the center of rotation in the optical axis direction. The correction unit is rotated with one point located on the optical axis or near the optical axis as the center, to thereby add the shift component and the tilt component to the optical axis.

In the zoom lenses of Embodiments, the tilt component with respect to the shift component is appropriately set, to thereby effectively reduce the eccentric aberration. The degree of an influence exerted on the eccentric aberration due to the generation of the tilt component depends on the magnitudes of the parameters: the distance R; and the thickness d2is in the conditional expression (1). For example, when the value of the distance R is reduced, the tilt component is increased for the amount of desired image blur correction, and hence a contribution to the eccentric aberration is increased. In addition, when the value of the thickness d2is is increased, a change amount of an optical path length when the tilt component is generated is increased, and hence a contribution to the eccentric aberration is increased.

The conditional expression (1) defines an absolute value of a ratio of the distance R from the correction lens unit to the center of rotation to the thickness d2is of the correction lens unit on the optical axis, If |R/d2is| in the conditional expression (1) exceeds an upper limit thereof and hence the distance from the correction lens unit to the center of rotation is too long, the tilt component of the correction lens unit becomes too small. As a result, the effect of reducing the eccentric aberration by the tilt component becomes insufficient. Alternatively, if |R/d2is| in the conditional expression (1) exceeds the upper limit and hence the thickness of the correction lens unit on the optical axis becomes too small, the change in the optical path length by the tilt component becomes small. As a result, the effect of reducing the eccentric aberration becomes insufficient.

On the other hand, if |R/d2is| in the conditional expression. (1) exceeds a lower limit thereof and hence the distance from the correction lens unit to the center of rotation is too short, when the shift component necessary for the desired image blur correction is intended to be obtained, the tilt component forms very large angle. As a result, many high-order eccentric aberrations occur due to the tilt component, and hence the cancel relationship with the shift component does not become satisfactory, which is not preferred. Alternatively, if |R/d2is| in the conditional expression (1) exceeds the lower limit and hence the thickness of the correction lens unit on the optical axis becomes to large, the change in optical path length by the tilt component becomes large, and hence many eccentric aberrations occur, which is not preferred.

Note that it is preferred to set the numerical value range of the conditional expression (1) as follows.

0.7<R/d2is|<17.3 (1a)

It is more preferred to set the numerical value range of the conditional expression (1a) as follows.

1.0<|R/d2is|<17.0 (1b)

As described above, according to Embodiments, in the zoom lens including, in order from the object side to the image side, the first lens unit having the positive refractive power and the second lens unit having the negative refractive power, which has the wide angle of field and the high zoom ratio, the image blur correction can be satisfactorily carried out. In particular, there is obtained the zoom lens having the high optical characteristic and the sufficient peripheral light amount ratio in which the effective diameter of the front lens is easy to reduce even when an image blur correction angle is increased.

It is preferred for Examples to satisfy one or more of the following conditional expressions. Here, f1 represents a focal length of the first lens unit L1, and f2 represents a focal length of the second lens unit L2. In addition, f2is represents a focal length of the correction lens unit, and fW represents a focal length of the entire system at the wide angle end.

In this case, it is preferred to satisfy one or more of the following conditional expressions.

−0.24<f2is/f1<−0.05 (2)

−2.5<f2is/d2is<−0.1 (3)

0.02<fW/f1<0.35 (4)

−10.5<f1/f2<−4.2 (5)

Next, the technical meanings of the above-mentioned conditional expressions are described. The conditional expression (2) defines a ratio of the negative focal length f2is of the correction lens unit to the focal length f1 of the first lens unit. If f2is/f1 in the conditional expression (2) exceeds an upper limit thereof and hence the negative focal length of the correction lens unit becomes too short (an absolute value of the focal length becomes small), the amount of eccentric aberration occurring due to the shift component during the image blur correction becomes too large. As a result, it becomes difficult to reduce the eccentric aberration by the tilt component.

On the other hand, if f2is/f1 in the conditional expression (2) exceeds a lower limit thereof and hence the negative focal length of the correction lens unit becomes too long (the absolute value of the focal length becomes large), the shift component to obtain a desired image blur correction angle becomes too large because an image stabilization sensitivity is too low. In this case, a driving stroke for the rotation of the correction lens unit becomes long, and hence a driving unit is increased in size, which is not preferred.

The conditional expression. (3) defines a ratio of the negative focal length f2is of the correction lens unit to the thickness d2is of the correction lens unit on the optical axis. If f2is/d2is in the conditional expression (3) exceeds an upper limit thereof and hence the negative focal length of the correction lens unit becomes too short, or the thickness of the correction lens unit on the optical axis becomes too large, the cancel relationship for the eccentric aberration that occurs due to the shift component and the tilt component during the image blur correction does not become satisfactory, which is not preferred.

On the other if f2is/d2is in the conditional expression (3) exceeds a lower limit thereof and hence the negative focal length of the correction lens unit becomes too long, or the thickness of the correction lens unit on the optical axis becomes too small, the refractive power of the correction lens unit becomes too weak, or the change in optical path length by the tilt component becomes small. In this case, effect of reducing the eccentric aberration becomes insufficient, which is not preferred.

The conditional expression (4) defines a ratio of the focal length fW of the entire system at the wide angle end to the focal length f1 of the first lens unit L1. If fW/f1 in the conditional expression (4) exceeds an umber limit thereof and hence the focal length of the entire system at the wide angle end becomes too long, it becomes difficult to widen an angle of field at the wide angle end although the aberration correction during the image blur correction becomes easy in the entire zoom range. On the other hand, if fW/f1 in the conditional expression (4) exceeds a lower limit thereof and hence the focal length of the entire system at the wide angle end becomes too short, the eccentric aberration during the image blur correction becomes difficult to correct in the entire zoom range although it becomes easy to widen an angle of field at the wide angle end.

The conditional expression (5) defines a ratio of the focal length f1 of the first lens unit L1 to the negative focal length f2 of the second lens unit L2. If f1/f2 in the conditional expression (5) exceeds an upper limit thereof and hence the negative focal length of the second lens unit L2 becomes too long (the absolute value of the focal length becomes large), the refractive power of the second lens unit L2 which mainly contributes to the variable power is weakened although the aberration correction becomes easy in the entire zoom range. As a result, the high zoom ratio becomes difficult to attain. On the other hand, if f1 /f2 in the conditional expression (5) exceeds a lower limit thereof and hence the negative focal length of the second lens unit L2 becomes too short (the absolute value of the focal length becomes small), the aberration correction becomes difficult in the entire zoom range although the high zoom ratio becomes easy to attain.

Note that, it is more preferred to set the numerical value range of the conditional expressions (2) to (5) as follows.

−0.23<f2is/f1<−0.06 (2a)

−2.2<f2is/d2is<−0.2 (3a)

0.03<fW/f1<0.31 (4a)

−10.2<f1/f2<−4.3 (5a)

It is still more preferred to set the numerical value range of the conditional expressions (2a) to (5a) as follows.

−0.22<f2is/f1<−0.07 (2b)

−1.9<f2is/d2is−−0.3 (3b)

0.04<fW/f1<0.29 (4b)

−9.9<f1/f2<−4.4 (5b)

In the zoom lenses of Embodiments, it is preferred that the refractive power of the third lens unit L3 be set positive. In the zoom lens including, in order from the object side to the image side, the first lens unit having the positive refractive power and the second lens unit having the negative refractive power, the refractive power of the third lens unit L1 is set negative. In addition, there is known a zoom lens having a four-unit configuration including, for example, in order from the object side to the image side, the lens units having the positive, negative, negative, and positive refractive powers.

However, when the refractive power of the third lens unit is set negative, the lens surface of the third lens unit, which is closest to the object side is liable to become a concave surface relating to the aberration correction. In this case, when the entire second lens unit or a part of the correction lens unit is rotated with one point located on the optical axis as the center on the image side, the lens units are liable to interfere with the third lens unit. As a result, it becomes difficult to narrow the interval between the second lens unit and the third lens unit, and hence it becomes difficult to reduce the entire system in size while the high zoom ratio is promoted.

In the zoom lenses of Embodiments, it is preferred that the correction lens unit be formed of the entire second lens unit. When a part of the second lens unit us used as the correction lens unit, the optical characteristic during the image blur correction can be satisfactorily maintained. At this time, however, the second lens unit needs to be divided into a plurality of lens units to control the drive thereof. For this reason, it becomes difficult to precisely control the drive during the zooming and the image blur correction.

Next, a digital camera (image pickup apparatus) according to an embodiment of the present invention, which uses the zoom lens of the present invention as a photographing optical system is described with reference to FIG. 13.

In FIG. 13 a reference numeral 20 represents a digital camera main body. A photographing optical system 21 includes the zoom lens of any one of Embodiments described above. An image pickup element 22 such as a CCD receives light corresponding to the object image by using the photographing optical system 21. A recording unit 23 records data on the object image the light corresponding to which is received by the image pickup element 22. A finder 24 is used to observe the object image displayed on a display element (not shown). The display element includes a liquid crystal panel or the like. The object image formed on the image pickup element 22 is displayed on the display element. A compact image pickup apparatus having the high optical characteristic can be realized by applying the zoom lens of the present invention to the image pickup apparatus such as a digital camera in such a manner.

Note that, the zoom lens of the present invention can be similarly applied to a single-lens reflex camera including a mirror lens.

Next, each of Numerical Embodiments, which correspond to each of Embodiments of the present invention, respectively, is described. In each of Numerical Embodiments, Symbol ri represents a radius of curvature of an i-th lens surface in order from the object side. Symbol di represents a lens thickness and an air gap between an i-th surface and an (i+1)th surface in order from the object side. Symbols ndi and vdi represent a refractive index and an Abbe number with respect to the d-line of glass of a material between the i-th surface and the (1+1)th surface in order from the object side, respectively. An aspherical shape is expressed by the expression below.

$$X = \frac{\frac{{H}^{2}}{R}}{1 + \sqrt{1 - ( 1 + K ) {( \frac{H}{R} )}^{2}}} + A 4 {H}^{4} + A 6 {H}^{6} + A 8 {H}^{8} + A 10 {H}^{10}$$

where the X axis corresponds to the optical axis direction, the H axis corresponds to the direction perpendicular to the optical axis, the light propagation direction is positive, symbol r represents a paraxial curvature radius, symbol K represents a conic constant, and symbols A4, A6, A8, and A10 represent aspherical coefficients, respectively,

In addition, [e+x] means x10^{+x} and [e−x] means x10^{-x}. Symbol BF is back focus, which is represented by an air-converted length from a final lens surface to a paraxial image plane. A total lens length is obtained by adding the length corresponding to the back focus BF to a distance from a forefront lens surface to the final lens surface. An aspherical surface is represented by adding the mark “*” after a surface number.

In the lens unit position data during the image blur correction, the center of rotation position represents the distance from the apex of the lens surface of the correction lens unit closest to the object side to the center of rotation. The plus sign means the image side when viewed from the correction lens unit. The tilt angle represents the rotation angle during the image blur correction. The plus sign means the counterclockwise direction in the lens cross-sectional views of Embodiments. Note that the image blur correction angle represents the correction angle at the center of the screen.

### Numerical Embodiment 1

Unit: mm
Surface data

| Surface number | r | d | nd | νd |
|---|---|---|---|---|
| 1 | 47.542 | 0.90 | 1.84666 | 23.9 |
| 2 | 28.475 | 2.74 | 1.49700 | 81.5 |
| 3 | 2493.581 | 0.20 | | |
| 4 | 26.865 | 2.17 | 1.69680 | 55.5 |
| 5 | 136.341 | (Variable) | | |
| 6 | 2436.982 | 1.03 | 1.85135 | 40.1 |
| 7* | 5.904 | 2.56 | | |
| 8 | −12.706 | 0.60 | 1.80400 | 46.6 |
| 9 | 37.693 | 0.20 | | |
| 10 | 14.605 | 1.37 | 1.94595 | 18.0 |
| 11 | −215.216 | (Variable) | | |
| 12* | 7.944 | 1.38 | 1.58313 | 59.4 |
| 13* | −59.910 | 0.88 | | |
| 14 (Stop) | ∞ | 1.39 | | |
| 15 | 10.467 | 0.60 | 1.94595 | 18.0 |
| 16 | 6.384 | 0.53 | | |
| 17 | 19.590 | 1.37 | 1.60311 | 60.6 |
| 18 | −18.355 | (Variable) | | |
| 19 | 452.291 | 0.50 | 1.48749 | 70.2 |
| 20 | 31.753 | (Variable) | | |
| 21 | 16.612 | 1.44 | 1.69680 | 55.5 |
| 22 | 153.432 | 0.60 | 1.72825 | 28.5 |
| 23 | 51.937 | (Variable) | | |
| 24 | ∞ | 0.80 | 1.51633 | 64.1 |
| 25 | ∞ | 0.88 | | |
| Image plane | ∞ | | | |

Aspherical surface data
Seventh surface

K = −2.35333e+000
A4 = 1.49919e−003
A6 = −2.81439e−006
A8 = 3.23263e−007
A10 = 1.76871e−008

Twelfth surface

K = 1.29966e+000
A4 = −1.03059e−003
A6 = −8.43554e−005
A8 = 5.54525e−006
A10 = −7.59601e−007

Thirteenth surface

K = 2.12676+002
A4 = −3.61241e−004
A6 = −6.62061−005
A8 = 4.12821e−006
A10 = −5.75474e−007

Various data

| Zoom ratio | | 13.31 | |
|---|---|---|---|
| | Wide angle | Intermediate | Telephoto |
| Focal length | 5.13 | 19.59 | 68.25 |
| F number | 3.02 | 4.73 | 5.93 |
| Half angle of field | 33.03 | 11.19 | 3.25 |
| (degrees) | | | |
| Image height | 3.33 | 3.88 | 3.88 |
| Total lens length | 49.53 | 56.32 | 75.76 |
| BF | 7.94 | 18.26 | 8.34 |
| d5 | 0.94 | 10.25 | 22.87 |
| d11 | 15.81 | 3.51 | 0.71 |
| d18 | 1.90 | 2.78 | 2.98 |
| d20 | 2.50 | 1.09 | 20.42 |
| d23 | 6.53 | 16.85 | 6.93 |

Zoom lens unit data

| Unit | First surface | Focal length |
|---|---|---|
| 1 | 1 | 38.39 |
| 2 | 6 | −6.36 |
| 3 | 12 | 11.44 |
| 4 | 19 | −70.08 |
| 5 | 21 | 34.69 |
| 6 | 24 | ∞ |

Correction lens unit data during blur collection

| Correction lens unit | First surface | | Last surface |
|---|---|---|---|
| | number 6 | | number 11 |
| Focal length f2is of correction | | −6.363 mm | |
| lens unit | | | |
| Thickness d2is of correction | | 5.756 mm | |
| lens unit | | | |
| Center of rotation position R | | 60.154 mm | |
| of correction lens unit | | | |
| | Wide angle | Intermediate | Telephoto |
| Tilt angle of | −0.49 degrees | −0.50 degrees | −1.00 degrees |
| correction | | | |
| lens unit | | | |
| Blur | −4.0 degrees | −3.0 degrees | −3.0 degrees |
| correction | | | |
| angle | | | |

### Numerical Embodiment 2

Unit: mm
Surface data

| Surface number | r | d | nd | νd |
|---|---|---|---|---|
| 1 | 53.041 | 1.35 | 1.84666 | 23.9 |
| 2 | 27.668 | 6.05 | 1.60311 | 60.6 |
| 3 | −440.882 | 0.18 | | |
| 4 | 24.922 | 3.45 | 1.69680 | 55.5 |
| 5 | 74.134 | (Variable) | | |
| 6 | 147.266 | 0.70 | 1.8800 | 40.8 |
| 7 | 7.285 | 2.97 | | |
| 8 | −111.952 | 0.60 | 1.80610 | 33.3 |
| 9 | 29.523 | 1.22 | | |
| 10 | −25.404 | 0.60 | 1.80400 | 46.6 |
| 11 | 40.496 | 0.27 | | |
| 12 | 20.278 | 1.94 | 1.92286 | 18.9 |
| 13 | −54.086 | (Variable) | | |
| 14 (Stop) | ∞ | (Variable) | | |
| 15* | 10.402 | 3.01 | 1.58313 | 59.4 |
| 16 | −129.903 | 4.39 | | |
| 17 | 56.301 | 0.60 | 1.80518 | 25.4 |
| 18 | 10.489 | 0.59 | | |
| 19* | 21.401 | 2.23 | 1.58313 | 59.4 |
| 20 | −36.073 | (Variable) | | |
| 21 | 13.790 | 3.07 | 1.69680 | 55.5 |
| 22 | −22.255 | 1.10 | 1.84666 | 25.9 |
| 23 | −236.089 | (Variable) | | |
| 24 | ∞ | 1.94 | 1.51633 | 64.1 |
| 25 | ∞ | 1.98 | | |
| Image plane | ∞ | | | |

Aspherical surface data

Fifteenth surface
K = −8.66524e−001
A4 = −1.99723e−006
A6 = 7.05266−008
A8 = 6.79053e−010
Nineteenth surf ace
K = −4.10770e−001
A4 = −2.43478e−005
A6 = 1.73933e−008
A8 −1.14367e−011

Various data

| Zoom ratio | | 9.80 | |
|---|---|---|---|
| | Wide angle | Intermediate | Telephoto |
| Focal length | 4.63 | 20.22 | 45.44 |
| F number | 1.85 | 2.61 | 2.88 |
| Half angle of field | | | |
| (degrees) | 32.92 | 8.44 | 3.78 |
| Image height | 3.00 | 3.00 | 3.00 |
| Total lens length | 78.39 | 78.39 | 78.39 |
| BF | 9.14 | 13.15 | 11.55 |
| d5 | 1.01 | 16.10 | 21.46 |
| d13 | 22.93 | 7.84 | 2.48 |
| d14 | 6.40 | 2.56 | 2.25 |
| d20 | 4.59 | 4.42 | 6.33 |
| d23 | 5.88 | 9.89 | 8.29 |

Zoom lens unit data

| Unit | First surface | Focal length |
|---|---|---|
| 1 | 1 | 36.96 |
| 2 | 6 | −7.42 |
| 3 | 15 | 21.10 |
| 4 | 21 | 21.02 |
| 5 | 24 | ∞ |

Correction lens unit data during blur collection

| Correction lens unit | First surface | | Last surface |
|---|---|---|---|
| | number 6 | | number 13 |
| Focal length f2is of correction | | −7.420 mm | |
| lens unit | | | |
| Thickness d2is of correction | | 8.300 mm | |
| lens unit | | | |
| Center of rotation position R | | 139.366 mm | |
| of correction lens unit | | | |
| | Wide angle | Intermediate | Telephoto |
| Tilt angle of | −0.32 degrees | −0.37 degrees | −0.37 degrees |
| correction | | | |
| lens unit | | | |
| Blur | −5.0 degrees | −3.0 degrees | −2.0 degrees |
| correction | | | |
| angle | | | |

### Numerical Embodiment 3

Unit: mm
Surface data

| Surface number | r | d | nd | νd |
|---|---|---|---|---|
| 1 | 94.821 | 1.50 | 1.84666 | 23.9 |
| 2 | 49.889 | 4.75 | 1.49700 | 81.5 |
| 3 | −368.278 | 0.15 | | |
| 4 | 42.147 | 3.92 | 1.49700 | 81.5 |
| 5 | 298.499 | 0.15 | | |
| 6 | 27.321 | 3.24 | 1.59282 | 68.6 |
| 7 | 52.988 | (Variable) | | |
| 8 | 75.612 | 0.60 | 2.00100 | 29.1 |
| 9 | 6.608 | 3.18 | | |
| 10 | −17.640 | 0.50 | 1.90826 | 38.7 |
| 11 | 77.849 | 0.10 | | |
| 12 | 14.745 | 3.89 | 1.95906 | 17.5 |
| 13 | −8.334 | 0.50 | 2.01819 | 25.0 |
| 14 | 32.494 | (Variable) | | |
| 15 (Stop) | ∞ | (Variable) | | |
| 16* | 13.428 | 3.61 | 1.58313 | 59.4 |
| 17* | −44.842 | 5.90 | | |
| 18 | 284.356 | 0.60 | 2.00100 | 29.1 |
| 19 | 10.068 | 0.02 | | |
| 20 | 10.228 | 2.83 | 1.48067 | 43.9 |
| 21 | −49.252 | (Variable) | | |
| 22* | 18.591 | 3.16 | 1.59201 | 67.0 |
| 23 | −14.943 | 0.50 | 1.84666 | 23.9 |
| 24 | −20.669 | (Variable) | | |
| 25 | ∞ | 1.85 | 1.51633 | 64.1 |
| 26 | ∞ | 1.45 | | |
| Image plane | ∞ | | | |

Aspherical surface data
Sixteenth surface

K = −3.69536e−002
A4 = −2.65283e−005
A6 = −4.94023e−008
A8 = 4.71186e−009

Seventeenth surface

K = 2.25732e+001
A4 = 7.04630e−005
A6 = 1.64565e−007
A8 = 7.84111e−009

Twenty-second surface

K = 6.29556e−002
A4 = −4.38688e−005
A6 = −1.13944e−007

Various Data

| Zoom ratio | | 98.52 | |
|---|---|---|---|
| | Wide angle | Intermediate | Telephoto |
| Focal length | 3.07 | 53.41 | 302.40 |
| F number | 1.85 | 8.14 | 9.00 |
| Half angle of field | 36.24 | 2.41 | 0.43 |
| (degrees) | | | |
| Image height | 2.25 | 2.25 | 2.25 |
| Total lens length | 110.05 | 110.05 | 110.05 |
| BF | 12.67 | 27.40 | 5.19 |
| d7 | 0.69 | 26.22 | 29.71 |
| d14 | 30.27 | 4.74 | 1.26 |
| d15 | 15.80 | 1.73 | 1.49 |
| d21 | 11.50 | 10.85 | 33.29 |
| d24 | 10.00 | 24.72 | 2.52 |

Zoom lens unit data

| Unit | First surface | Focal length |
|---|---|---|
| 1 | 1 | 41.57 |
| 2 | 8 | −5.01 |
| 3 | 16 | 30.47 |
| 4 | 22 | 18.49 |
| 5 | 25 | ∞ |

Correction lens unit data during blur collection

| Correction lens unit | First surface | | Last surface |
|---|---|---|---|
| | number 8 | | number 14 |
| Focal length f2is of correction | | −5.008 mm | |
| lens unit | | | |
| Thickness d2is of correction | | 8.775 mm | |
| lens unit | | | |
| Center of rotation position R | | 40.106 mm | |
| of correction lens unit | | | |
| | Wide angle | Intermediate | Telephoto |
| Tilt angle of | −0.68 degrees | −1.30 degrees | −0.50 degrees |
| correction | | | |
| lens unit | | | |
| Slur | −4.0 degrees | −2.0 degrees | −0.5 degrees |
| correction | | | |
| angle | | | |

TABLE 1

| Conditional | Number Embodiment (Embodiment) | | |
|---|---|---|---|
| Expression | 1 | 2 | 3 |
| (1) | 10.45 | 16.79 | 4.57 |
| (2) | −0.166 | −0.201 | −0.120 |
| (3) | −1.11 | −0.89 | −0.57 |
| (4) | 0.134 | 0.125 | 0.074 |
| (5) | −6.03 | −4.98 | −8.30 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2:013-269056, filed Dec. 26, 2013, which is hereby incorporated by reference herein in its entirety.

What is claimed is:

1. A zoom lens, comprising, in order from an object side to an image side:
a first lens unit having a positive refractive power;
a second lens unit having a negative refractive power;
a third lens unit having a positive refractive power; and
a rear lens unit comprising at least one lens unit,
the zoom lens being configured such that an interval between two lens units which are adjacent to each other is changed during zooming,
wherein at least a part of the second lens unit comprises a correction lens unit rotatable during an image blur correction with one point located on an optical axis or near the optical axis as a center of rotation, the center of rotation being located closer to the image side than an intersection point between the optical axis and a lens surface of the correction lens unit where the lens surface is disposed closest to the object side, and
wherein the following conditional expression is satisfied;
0.5<|R/d2is51 <17.5,
where R represents a distance in a direction of the optical axis from the intersection point to the center of rotation, and d2is represents a thickness of the correction lens unit on the optical axis.

2. A zoom lens according to claim 1, wherein the following conditional expression is satisfied:
−0.24<f2is/f1<−0.05,
where f1 represents a focal length of the first lens unit, and f2is represents a focal length of the correction lens unit.

3. A zoom lens according to claim 1, wherein the following conditional expression is satisfied:
−2.5<f2is/d2is<−0.1,
where f2is represents a focal length of the correction lens unit.

4. A zoom lens according to claim 1, wherein the following conditional expression is satisfied:
0.02<fW/f1<0.35,
where f1 represents a focal length of the first lens unit, and fW represents a focal length of the zoom lens at a wide angle end.

5. A zoom lens according to claim 1, wherein the following conditional expression is satisfied:
−10.5<f1/f2<−4.2,
where f1 represents a focal length of the first lens unit, and f2 represents a focal length of the second lens unit.

6. A zoom lens according to claim 1, wherein
the rear lens unit consists of, in order from the object side to the image side, a fourth lens unit having a negative refractive power and a fifth lens unit having a positive refractive power, and
wherein, during zooming from a wide angle end to a telephoto end, the first lens unit, the third lens unit, and the fourth lens unit are moved toward the object side, the second lens unit is moved along a locus convex to the image side, and the fifth lens unit is moved along a locus convex to the object side.

7. A zoom lens according to claim 1,
wherein the rear lens unit consists of a fourth lens unit having a positive refractive power, and
wherein, during zooming from a wide angle end to a telephoto end, the second lens unit is moved toward the image side, the third lens unit is moved toward the object side, and the fourth lens unit is moved along a locus convex to the object side.

8. An image pickup apparatus, comprising:
a zoom lens; and
an image pickup element configured to receive an image formed by the zoom lens,
wherein the zoom lens comprises, in order from an object side to an image side:
a first lens unit having a positive refractive power;
a second lens unit having a negative refractive power;
a third lens unit having a positive refractive power; and
a rear lens unit comprising at least one lens unit,
the zoom lens being configured such that an interval between two lens units which are adjacent to each other is changed during zooming,
wherein at least part of the second lens unit comprises a correction lens unit rotatable during an image blur correction with one point located on an optical axis or near the optical axis as a center of rotation, the center of rotation being located closer to the image side than an intersection point between the optical axis and a lens surface of the correction lens unit where the lens surface is disposed closest to the object side, and
wherein the following conditional expression is satisfied:
0.5<|R/d2is|<17.5,
where R represents a distance in a direction of the optical axis from the intersection point to the center of rotation, and d2is represents a thickness of the correction lens unit on the optical axis.
